(19) United States
(12) Patent Application Publication
(10) Pub. No.: US 2026/0189997 A1
(43) Pub. Date: Jul. 2, 2026

(54) METHOD AND APPARATUS FOR REPORTING INFORMATION

(71) Applicant: Beijing Xiaomi Mobile Software Co., Ltd., Beijing (CN)

(72) Inventor: Xiaowei JIANG, Beijing (CN)

(73) Assignee: Beijing Xiaomi Mobile Software Co., Ltd., Beijing (CN)

(21) Appl. No.: 18/858,663

(22) PCT Filed: Apr. 22, 2022
(86) PCT No.: PCT/CN2022/088634

§ 371 Date: Oct. 21, 2024

(51) Int. Cl. H04W 36/00; H04W 36/36

(52) U.S. Cl. CPC H04W 36/0079; H04W 36/362

(57) ABSTRACT

A method for reporting information includes: transmitting secondary cell group failure information to a network device in response to detecting that a specified event occurs in a secondary cell group, where the secondary cell group failure information includes information related to a conditional primary secondary cell (PSCell) addition or change.

### CROSS-REFERENCE

The present application is a U.S. National Stage of International Application No. PCT/CN2022/088634, filed on Apr. 22, 2022, the contents of all of which are incorporated herein by reference in their entireties for all purposes.

### BACKGROUND OF THE INVENTION

In a 5G new radio (NR) system, a conditional primary secondary cell (PSCell) addition and/or change is supported, at most two conditional triggered events for the PSCell addition or change can be configured by a network, and the PSCell addition or change is initiated by a terminal after all the configured conditional triggered events are fulfilled.

### SUMMARY OF THE INVENTION

The disclosure relates to the technical field of communication, in particular to a method and apparatus for reporting information.

An example in a first aspect of the disclosure provides a method for reporting information. The method is performed by a terminal device, and includes: transmitting secondary cell group failure information to a network device in response to detecting that a specified event occurs in a secondary cell group, where the secondary cell group failure information includes information related to a conditional primary secondary cell (PSCell) addition or change.

An example in a second aspect of the disclosure provides a method for reporting information. The method is performed by a network device, and includes: receiving secondary cell group failure information transmitted by a terminal device, where the secondary cell group failure information includes information related to a conditional primary secondary cell (PSCell) addition or change.

An example in a third aspect of the disclosure provides a communication apparatus. The apparatus includes a processor and a memory. The memory stores a computer program. The processor executes the computer program stored in the memory to cause the apparatus to perform the method for reporting information according to the example in the first aspect.

An example in a fourth aspect of the disclosure provides a communication apparatus. The apparatus includes a processor and an interface circuit. The interface circuit is configured to receive a code instruction and transmit the code instruction to the processor. The processor is configured to run the code instruction to cause the apparatus to perform the method for reporting information according to the example in the first aspect.

An example in a fifth aspect of the disclosure provides a non-transitory computer-readable storage medium, configured to store an instruction. The instruction causes the method for reporting information according to the example in the first aspect to be implemented when executed.

Additional aspects and advantages of the disclosure will partially be set forth in the following description, will partially become apparent from the following description, or will be learned by practice of the disclosure.

### BRIEF DESCRIPTION OF DRAWINGS

In order to more clearly illustrate the examples of the disclosure or the technical solution in the prior art, the accompanying drawings required for the examples of the disclosure or the prior art will be explained below.

FIG. 1 is a schematic diagram of an architecture of a communication system according to an example of the disclosure;

FIG. 2 is a flowchart of a method for reporting information according to an example of the disclosure;

FIG. 3 is a flowchart of a method for reporting information according to an example of the disclosure;

FIG. 4 is a flowchart of a method for reporting information according to an example of the disclosure;

FIG. 5 is a flowchart of a method for reporting information according to an example of the disclosure;

FIG. 6 is a flowchart of a method for reporting information according to an example of the disclosure;

FIG. 7 is a flowchart of a method for reporting information according to an example of the disclosure;

FIG. 8 is a schematic structural diagram of an apparatus for reporting information according to an example of the disclosure;

FIG. 9 is a schematic structural diagram of an apparatus for reporting information according to an example of the disclosure;

FIG. 10 is a schematic structural diagram of another apparatus for reporting information according to an example of the disclosure; and

FIG. 11 is a schematic structural diagram of a chip according to an example of the disclosure.

### DETAILED DESCRIPTION OF THE INVENTION

Description will be made in detail to illustrative examples here, and their instances are illustrated in the accompanying drawings. When the following description relates to the accompanying drawings, the same numbers in different accompanying drawings denote the same or similar elements, unless indicated otherwise. The embodiments described in the following illustrative examples do not represent all embodiments consistent with the disclosure. Rather, they are merely instances of apparatus and methods consistent with some aspects of the examples of the disclosure as detailed in the appended claims.

The terms used in the examples of the disclosure are for the purpose of describing particular examples merely and are not intended to limit the examples of the disclosure. As used in the examples and the appended claims of the disclosure, singular forms “a”, “an” and “the” are intended to include plural forms as well, unless otherwise clearly indicated in the context. It should also be understood that the term “and/or” as used here refers to and encompasses any or all possible combinations of one or more of associated items listed.

It should be understood that although the terms of first, second, third, etc. may be employed in the examples of the disclosure to describe various information, such information should not be limited to these terms. These terms are merely used to distinguish the same type of information from each other. For example, first information may also be referred to as second information, and similarly, second information may also be referred to as first information, without departing from the scope of the examples of the disclosure. The word “if” as used here may be construed to mean “at the time of”, “when” or “in response to determining”, depending on the context.

Examples of the disclosure are described in detail below, and instances of the examples are illustrated in the drawings, in which same or similar reference numerals refer to the same or similar elements. The examples described below by reference to the drawings are illustrative for explaining the disclosure and are not to be construed as limiting the disclosure.

In order to better understand a method for reporting information disclosed in the examples of the disclosure, a communication system to which the example of the disclosure is applicable is first described below.

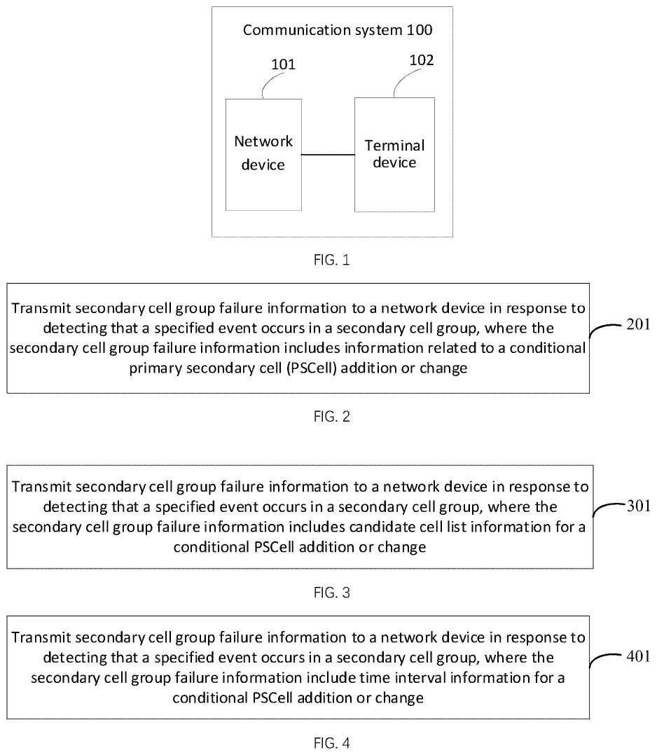

With reference to FIG. 1, FIG. 1 is a schematic diagram of an architecture of a communication system 100 according to an example of the disclosure. The communication system 100 may include, but is not limited to, one first network device, one second network device and one terminal device. The number and form of devices shown in FIG. 1 are only illustrative and do not constitute a limitation to the example of the disclosure. The communication system may include two or more network devices and two or more terminal devices in an actual application. For example, the communication system 100 shown in FIG. 1 includes one network device 101 and one terminal device 102.

It should be noted that the technical solution of the example of the disclosure can be applied to various communication systems, for example, a long term evolution (LTE) system, a fifth-generation (5G) mobile communication system, a 5G new radio system, or other future new mobile communication systems, etc.

The network device 101 in the example of the disclosure is an entity on a network side for transmitting or receiving signals. For example, the network device 101 may be an evolved NodeB (eNB), a transmission reception point (TRP), a next generation NodeB (gNBs) in an NR system, a base station in other future mobile communication systems, or an access nodes in a wireless fidelity (WiFi) system, etc. The example of the disclosure does not limit a particular technology and a particular device form used by the network devices. The network device provided in the example of the disclosure may be composed of a central unit (CU) and a distributed unit (DU). The CU may also be referred to as a control unit. By using a CU-DU structure, protocol layers of the network device, such as a base station, may be split, functions of some protocol layers are centrally controlled by the CU, and functions of some or all of the remaining protocol layers are distributed in the DU, and the DU is centrally controlled by the CU.

The terminal device 102 in the example of the disclosure is an entity on a user side configured to receive or transmit signals, such as a mobile phone. The terminal device may also be referred to as a terminal, user equipment (UE), a mobile station (MS), a mobile device (MT), etc. The terminal device may be a car with a communication function, a smart car, a mobile phone, a wearable device, a Pad, a computer with a radio transceiver function, a virtual reality (VR) terminal device, an augmented reality (AR) terminal device, a radio terminal device in industrial control, a radio terminal device in self-driving, a radio terminal device in remote medical surgery, a radio terminal device in a smart grid, a radio terminal device in transportation safety, a radio terminal device in a smart city, a radio terminal device in smart home, etc. The example of the disclosure does not limit a particular technology and a particular device configuration used by the terminal device.

In a 5G new radio (NR) system, a conditional primary secondary cell (PSCell) addition or change (CPAC) is supported, at most two conditional triggered events for the conditional PSCell addition or change can be configured for the terminal device 102 by the network device 101, and the PSCell addition or change is initiated by the terminal device 102 after all the configured triggered events are fulfilled.

Moreover, if the terminal device 102 detects a radio link failure (RLF) or detects a beam failure on a secondary cell group (SCG), an addition or change of the SCG fails, an SCG configuration failure occurs, or an integrity check failure occurs on the SCG, an SCGFailureInformation message is transmitted to a base station by the terminal.

Currently, the SCGFailureInformation message only records a failure type, measurement results of a serving cell and a neighboring cell, a source PSCell ID in a PSCell change failure, a target PSCell ID, a time from performing the PSCell change to occurrence of the SCG failure, and information related to a random access failure.

However, the SCGFailureInformation message does not include information related to a conditional PSCell addition or change (CPAC). The information relates to the CPAC helps a network to be informed of a reason for the SCG failure.

It can be understood that the communication system described in the examples of the disclosure is for the purpose of more clearly illustrating the technical solutions provided in the examples of the disclosure, and does not constitute a limitation on the technical solutions provided in the examples of the disclosure. Those skilled in the art will know that the technical solutions provided in the examples of the disclosure are also applicable to similar technical problems along with evolution of a system architecture and emergence of new service scenes.

The method and apparatus for reporting information provided in the disclosure are described in detail below in conjunction with the accompanying drawings.

With reference to FIG. 2, FIG. 2 is a flowchart of a method for reporting information according to an example of the disclosure. It should be noted that the method for reporting information in the example of the disclosure is performed by the terminal device. The method may be performed independently or in conjunction with any one of other examples of the disclosure. As shown in FIG. 2, the method may include step 201.

In step 201, secondary cell group failure information is transmitted to a network device in response to detecting that a specified event occurs in a secondary cell group, where the secondary cell group failure information includes information related to a conditional primary secondary cell (PSCell) addition or change.

In the example of the disclosure, the terminal device triggers reporting of the secondary cell group failure information in response to detecting that the specified event occurs in the secondary cell group (SCG), the secondary cell group failure information is transmitted by the terminal device to the network device. The secondary cell group failure information includes the information related to the conditional PSCell addition or change.

In the example of the disclosure, the information related to the conditional PSCell addition or change includes at least one of the following:
candidate cell list information for the conditional PSCell addition or change;
a time interval from receiving conditional configuration information for the conditional PSCell addition or change to performing the conditional PSCell addition or change;
a time interval from receiving the conditional configuration information for the conditional PSCell addition or change to occurring a radio link failure;
a time interval from receiving the conditional configuration information for the conditional PSCell addition or change to occurring a beam failure;
a type of the PSCell addition or change last performed before detecting that the specified event occurs in the secondary cell group; or
the identity of a primary secondary cell failing in addition.

The conditional configuration information for the conditional PSCell addition or change refers to a conditional triggered event configured by the network device to the terminal device to trigger the PSCell addition or change.

Types of the PSCell addition or change include a conditional PSCell addition, a conditional PSCell change, a PSCell addition, and a PSCell change.

In some embodiments, the candidate cell list information for the conditional PSCell addition or change includes a global cell identity and a tracking area code of each candidate cell.

In some embodiments, the candidate cell list information for the conditional PSCell addition or change includes a physical cell identity and a carrier frequency of each candidate cell.

In some embodiments, the identity of the primary secondary cell failing in addition includes a physical cell identity and a carrier frequency of a PSCell failing in addition.

It should be noted that in the example of the disclosure, the information related to the conditional PSCell addition or change may be indicated by indication information in the secondary cell group failure information. For example, as an instance, the information related to the conditional PSCell addition or change may be indicated by an information element (IE) in the secondary cell group failure information. The IE may be newly defined. In some embodiments, an existing IE may also be reused to indicate the information related to the conditional PSCell addition or change.

Alternatively, in some embodiments, the specified event includes at least one of the following, that is, the method provided in the example of the disclosure is applicable to at least one of the following situations of triggering reporting of the secondary cell group failure information:
a radio link failure for the secondary cell group;
reconfiguration with a synchronization failure of the secondary cell group; or
detecting a beam failure of the primary secondary cell (PSCell) of the secondary cell group while the secondary cell group is deactivated.

Alternatively, in some embodiments, the specified event may further include at least one of the following, that is, the method provided in the example of the disclosure is further applicable to at least one of the following situations of triggering reporting the secondary cell group failure information:
an integrity check failure from secondary cell group lower layers concerning signaling radio bearer type 3 (SRB3); or
a secondary cell group configuration failure.

Alternatively, in some embodiments, the method provided in the example of the disclosure is inapplicable to a situation of detecting that at least one of the following events occurs in the secondary cell group, that is, the method is inapplicable to at least one of the following situations of triggering reporting of the secondary cell group failure information:

an integrity check failure from secondary cell group lower layers concerning signaling radio bearer type 3 (SRB3);

a secondary cell group configuration failure; or

detecting a beam failure of a primary secondary cell (PSCell) of the secondary cell group while the secondary cell group is deactivated.

It can be understood that in the example of the disclosure, the situation of triggering reporting of the secondary cell group failure information to which the method is applicable or inapplicable may be specified by a protocol or determined by an indication of the network device.

Moreover, it should be noted that the secondary cell group (SCG) in the example of the disclosure may be an NR SCG or an evolved universal terrestrial radio access (EUTRA) SCG. If the SCG is an NR SCG, the secondary cell group failure information transmitted by the terminal device to the network device is SCGFailureInformation, that is, the information related to the conditional PSCell addition or change is included in the SCGFailureInformation. If the SCG is an EUTRA SCG, the secondary cell group failure information transmitted by the terminal device to the network device is SCGFailureInformationEUTRA, that is, the information related to the conditional PSCell addition or change is included in the SCGFailureInformationEUTRA.

In summary, the secondary cell group failure information is transmitted to the network device in response to detecting that the specified event occurs in the secondary cell group. The secondary cell group failure information includes the information related to the conditional primary secondary cell (PSCell) addition or change. Thus, when a secondary cell group failure occurs, the information related to the conditional primary secondary cell (PSCell) addition or change can also be obtained by the network device, information related to the secondary cell group failure can be more comprehensively obtained by the network device, a reason for the secondary cell group failure can be more accurately analyzed, and communication efficiency of a system can be effectively improved.

With reference to FIG. 3, FIG. 3 is a flowchart of a method for reporting information according to an example of the disclosure. It should be noted that the method for reporting information in the example of the disclosure is performed by the terminal device. The method may be performed independently or in conjunction with any one of other examples of the disclosure. As shown in FIG. 3, the method may include step 301.

In step 301, secondary cell group failure information is transmitted to a network device in response to detecting that a specified event occurs in a secondary cell group, where the secondary cell group failure information includes candidate cell list information for a conditional PSCell addition or change.

In the example of the disclosure, the secondary cell group failure information transmitted by the terminal device to the network device includes the candidate cell list information for the conditional PSCell addition or change.

In the example of the disclosure, the candidate cell list information for the conditional PSCell addition or change may be indicated by indication information in the secondary cell group failure information. For example, candidate cell list information may be indicated by an information element (IE) in the secondary cell group failure information. The IE may be newly defined. In some embodiments, an existing IE may also be reused.

As an instance, it is defined that the secondary cell group failure information includes an information element cpacCandidateCellList, which is configured to indicate the candidate cell list information for the conditional PSCell addition or change.

In some embodiments, in response to determining that a reason for a secondary cell group failure is a PSCell addition or change failure and that available conditional configuration information for the conditional primary secondary cell (PSCell) addition or change exists, the candidate cell list information for the conditional PSCell addition or change includes a global cell identity and a tracking area code of each candidate cell, or includes a physical cell identity and a carrier frequency of each candidate cell.

The conditional configuration information for the conditional PSCell addition or change refers to a conditional triggered event configured by the network device to the terminal device to trigger the PSCell addition or change.

In some embodiments, in response to determining that a reason for a secondary cell group failure is a PSCell addition or change failure and that available conditional configuration information for the conditional primary secondary cell (PSCell) addition or change exists, the cpacCandidateCellList is set to include the global cell identity and the tracking area code of each candidate cell or the physical cell identity and the carrier frequency of each candidate cell for the PSCell addition and change in conditionalRRCReconfig. The conditionalRRCReconfig is conditional Radio Resource Control (RRC) Reconfiguration message.

It should be noted that if the reason for the secondary cell group failure is the PSCell addition or change failure, the terminal device may detect that the specified event occurring in the secondary cell group is a failure of reconfiguration with synchronization of the secondary cell group.

Moreover, it should be noted that the secondary cell group (SCG) in the example of the disclosure may be an NR SCG or an EUTRA SCG. If the SCG is an NR SCG, the secondary cell group failure information transmitted by the terminal device to the network device is SCGFailureInformation, that is, the information element cpacCandidateCellList is included in the SCGFailureInformation. If the SCG is an EUTRA SCG, the secondary cell group failure information transmitted by the terminal device to the network device is SCGFailureInformationEUTRA, that is, the information element cpacCandidateCellList is included in the SCGFailureInformationEUTRA.

Alternatively, in some embodiments, the candidate cell list information for the conditional primary secondary cell (PSCell) addition or change does not include a serving cell and a neighboring cell in the secondary cell group failure information.

That is, as an instance, if the secondary cell group is an NR SCG, the cpacCandidateCellList does not include a candidate cell in measResultNeighCellListNR in MeasResultSCG-Failure in the SCGFailureInformation. If the secondary cell group is an EUTRA SCG, the cpacCandidateCellList does not include a candidate cell in measResultNeighCellList in measResultSCG-FailureMRDC in the SCGFailureInformationEUTRA.

In summary, the secondary cell group failure information is transmitted to the network device in response to detecting that the specified event occurs in the secondary cell group. The secondary cell group failure information includes the candidate cell list information for the conditional PSCell addition or change. Thus, when a secondary cell group failure occurs, the information related to the conditional primary secondary cell (PSCell) addition or change can also be obtained by the network device, information related to the secondary cell group failure can be more comprehensively obtained by the network device, a reason for the secondary cell group failure can be more accurately analyzed, and communication efficiency of a system can be effectively improved.

With reference to FIG. 4, FIG. 4 is a flowchart of a method for reporting information according to an example of the disclosure. It should be noted that the method for reporting information in the example of the disclosure is performed by the terminal device. The method may be performed independently or in conjunction with any one of other examples of the disclosure. As shown in FIG. 4, the method may include step 401.

In step 401, secondary cell group failure information is transmitted to a network device in response to detecting that a specified event occurs in a secondary cell group, where the secondary cell group failure information include time interval information for a conditional PSCell addition or change.

In the example of the disclosure, the secondary cell group failure information transmitted by the terminal device to the network device includes the time interval information for the conditional PSCell addition or change.

The time interval information for the conditional PSCell addition or change includes at least one of the following:
a time interval from receiving conditional configuration information for the conditional PSCell addition or change to performing the conditional PSCell addition or change;
a time interval from receiving the conditional configuration information for the conditional PSCell addition or change to occurring a radio link failure; or
a time interval from receiving the conditional configuration information for the conditional PSCell addition or change to occurring a beam failure.

The conditional configuration information for the conditional PSCell addition or change refers to a conditional triggered event configured by the network device to the terminal device to trigger the PSCell addition or change.

In the example of the disclosure, the time interval information for the conditional PSCell addition or change may be indicated by indication information in the secondary cell group failure information. For example, candidate cell list information may be indicated by an information element (IE) in the secondary cell group failure information. The IE may be newly defined. In some embodiments, an existing IE may also be reused.

As an instance, it is defined that the secondary cell group failure information includes an information element timeSinceCPACReconfig, which is configured to indicate the time interval information for the conditional PSCell addition or change.

In some embodiments, in response to determining that a reason for a secondary cell group failure is a PSCell addition or change failure, the information related to the conditional PSCell addition or change includes the time interval from receiving the conditional configuration information for the conditional PSCell addition or change to performing the conditional PSCell addition or change.

As an instance, in response to determining that the reason for the secondary cell group failure is the PSCell addition or change failure, the timeSinceCPACReconfig is set to be the time interval from receiving the conditional configuration information for the PSCell addition or change to performing the PSCell addition or change.

It should be noted that if the reason for the secondary cell group failure is the PSCell addition or change failure, the terminal device may detect that the specified event occurring in the secondary cell group is a failure of reconfiguration with synchronization of the secondary cell group.

In some embodiments, in response to determining that a reason for a secondary cell group failure is a radio link failure, the information related to the conditional PSCell addition or change includes the time interval from receiving the conditional configuration information for the conditional PSCell addition or change to occurring the radio link failure.

As an instance, in response to determining that the reason for the secondary cell group failure is the radio link failure, the timeSinceCPACReconfig is set to be the time interval from receiving the conditional configuration information for the conditional PSCell addition or change to occurring the radio link failure.

It should be noted that if the reason for the secondary cell group failure is the PSCell addition or change failure, the terminal device may detect that the specified event occurring in the secondary cell group is the radio link failure of the secondary cell group.

In some embodiments, in response to determining that a reason for a secondary cell group failure is a beam failure, the information related to the conditional PSCell addition or change includes the time interval from receiving the conditional configuration information for the conditional PSCell addition or change to occurring the beam failure.

As an instance, in response to determining that the reason for the secondary cell group failure is the beam failure, the timeSinceCPACReconfig is set to be the time interval from receiving the conditional configuration information for the conditional PSCell addition or change to occurring the beam failure.

It should be noted that if the reason for the secondary cell group failure is the PSCell addition or change failure, the terminal device may detect that the specified event occurring in the secondary cell group is detecting a beam failure of the primary secondary cell (PSCell) of the secondary cell group while the secondary cell group is deactivated.

Moreover, it should be noted that the secondary cell group (SCG) in the example of the disclosure may be an NR SCG or an EUTRA SCG. If the SCG is an NR SCG, the secondary cell group failure information transmitted by the terminal device to the network device is SCGFailureInformation, that is, the information element timeSinceCPACReconfig is included in the SCGFailureInformation. If the SCG is an EUTRA SCG, the secondary cell group failure information transmitted by the terminal device to the network device is SCGFailureInformationEUTRA, that is, the information element timeSinceCPACReconfig is included in the SCGFailureInformationEUTRA.

In summary, the secondary cell group failure information is transmitted to the network device in response to detecting that the specified event occurs in the secondary cell group. The secondary cell group failure information includes the time interval information for the conditional PSCell addition or change. Thus, when a secondary cell group failure occurs, the information related to the conditional primary secondary cell (PSCell) addition or change can also be obtained by the network device, information related to the secondary cell group failure can be more comprehensively obtained by the network device, a reason for the secondary cell group failure can be more accurately analyzed, and communication efficiency of a system can be effectively improved.

With reference to FIG. 5, FIG. 5 is a flowchart of a method for reporting information according to an example of the disclosure. It should be noted that the method for reporting information in the example of the disclosure is performed by the terminal device. The method may be performed independently or in conjunction with any one of other examples of the disclosure. As shown in FIG. 5, the method may include step 501.

In step 501, secondary cell group failure information is transmitted to a network device in response to detecting that a specified event occurs in a secondary cell group, where the secondary cell group failure information includes a type of a primary secondary cell (PSCell) addition or change last performed before detecting that the specified event occurs in the secondary cell group.

In the example of the disclosure, the secondary cell group failure information transmitted by the terminal device to the network device includes the type of the PSCell addition or change last performed before detecting that the specified event occurs in the secondary cell group.

In the example of the disclosure, the type of the PSCell addition or change last performed before detecting an SCG failure may be indicated by indication information in the secondary cell group failure information. For example, candidate cell list information may be indicated by an information element (IE) in the secondary cell group failure information. The IE may be newly defined. In some embodiments, an existing IE may also be reused.

As an instance, it is defined that the secondary cell group failure information includes an information element LastCAPCType, which is configured to indicate the type of the PSCell addition or change last performed before detecting that the specified event occurs in the secondary cell group.

In the example of the disclosure, types of the PSCell addition or change include a conditional PSCell addition, a conditional PSCell change, a PSCell addition, and a PSCell change.

As an instance, if the type of the PSCell addition or change last performed before detecting an SCG failure is the conditional PSCell addition, the LastCAPCType is set to be ConndPScellAddition.

If the type of the PSCell addition or change last performed before detecting an SCG failure is the conditional PSCell change, the LastCAPCType is set to be CondPScellChange.

If the type of the PSCell addition or change last performed before detecting an SCG failure is the PSCell addition, the LastCAPCType is set to be PScellAddition.

If the type of the PSCell addition or change last performed before detecting an SCG failure is the PSCell change, the LastCAPCType is set to be PScellChange.

Alternatively, in some embodiments, the specified event includes at least one of the following, that is, the method provided in the example of the disclosure is applicable to at least one of the following situations of triggering reporting of the secondary cell group failure information:
a radio link failure for the secondary cell group;
reconfiguration with a synchronization failure of the secondary cell group; or
detecting a beam failure of the primary secondary cell (PSCell) of the secondary cell group while the secondary cell group is deactivated.

Alternatively, in some embodiments, the specified event may further include at least one of the following, that is, the method provided in the example of the disclosure is further applicable to at least one of the following situations of triggering reporting the secondary cell group failure information:
an integrity check failure from secondary cell group lower layers concerning signaling radio bearer type 3 (SRB3); or
a secondary cell group configuration failure.

Moreover, it should be noted that the secondary cell group (SCG) in the example of the disclosure may be an NR SCG or an EUTRA SCG. If the SCG is an NR SCG, the secondary cell group failure information transmitted by the terminal device to the network device is SCGFailureInformation, that is, the information element LastCAPCType is included in the SCGFailureInformation. If the SCG is an EUTRA SCG, the secondary cell group failure information transmitted by the terminal device to the network device is SCGFailureInformationEUTRA, that is, the information element LastCAPCType is included in the SCGFailureInformationEUTRA.

In summary, the secondary cell group failure information is transmitted to the network device in response to detecting that the specified event occurs in the secondary cell group. The secondary cell group failure information includes the type of the primary secondary cell (PSCell) addition or change last performed before detecting that the specified event occurs in the secondary cell group. Thus, when a secondary cell group failure occurs, the information related to the conditional primary secondary cell (PSCell) addition or change can also be obtained by the network device, information related to the secondary cell group failure can be more comprehensively obtained by the network device, a reason for the secondary cell group failure can be more accurately analyzed, and communication efficiency of a system can be effectively improved.

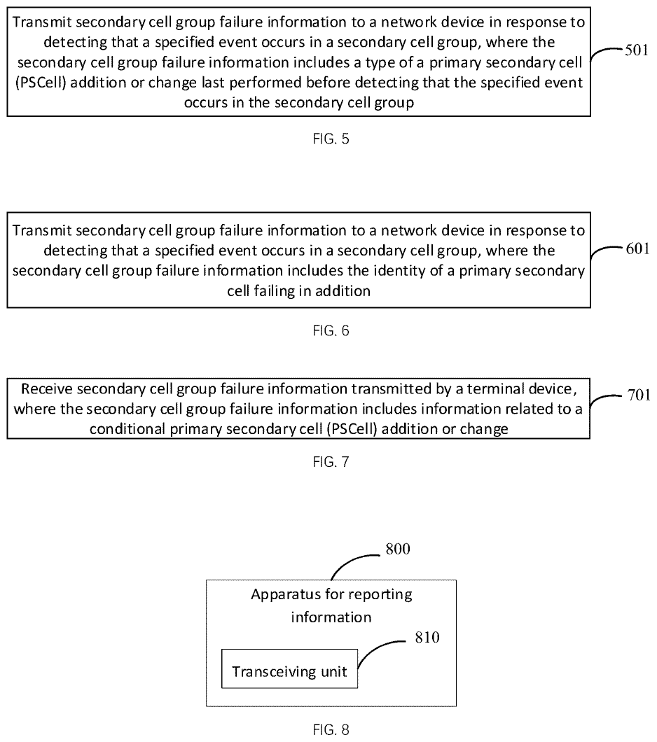

With reference to FIG. 6, FIG. 6 is a flowchart of a method for reporting information according to an example of the disclosure. It should be noted that the method for reporting information in the example of the disclosure is performed by the terminal device. The method may be performed independently or in conjunction with any one of other examples of the disclosure. As shown in FIG. 6, the method may include step 601.

In step 601, secondary cell group failure information is transmitted to a network device in response to detecting that a specified event occurs in a secondary cell group, where the secondary cell group failure information includes the identity of a primary secondary cell failing in addition.

In the example of the disclosure, the secondary cell group failure information transmitted by the terminal device to the network device includes the identity of the primary secondary cell failing in addition.

In the example of the disclosure, the identity of the PSCell failing in addition may be indicated by indication information in the secondary cell group failure information. For example, candidate cell list information may be indicated by an information element (IE) in the secondary cell group failure information. The IE may be newly defined. In some embodiments, an existing IE may also be reused.

As an instance, the information element failedPSCellId in the secondary cell group failure information is reused to indicate the identity of the PSCell failing in addition. It may be understood that in some embodiments, an IE may be newly defined to indicate the identity of the PSCell failing in addition.

In some embodiments, in response to determining that a reason for a secondary cell group failure is a PSCell addition failure, the information related to the conditional PSCell addition or change includes the identity of the PSCell failing in addition. The identity of the PSCell failing in addition includes a physical cell identity and a carrier frequency of the PSCell.

As an instance, in response to determining that a reason for a secondary cell group failure is a PSCell addition or change failure, failedPSCellId is set to be a physical cell identity and a carrier frequency of a PSCell to be added.

It should be noted that if the reason for the secondary cell group failure is the PSCell addition failure, the terminal device may detect that the specified event occurring in the secondary cell group is a failure of reconfiguration with synchronization of the secondary cell group.

Moreover, it should be noted that the secondary cell group (SCG) in the example of the disclosure may be an NR SCG or an EUTRA SCG. If the SCG is an NR SCG, the secondary cell group failure information transmitted by the terminal device to the network device is SCGFailureInformation, that is, the information element failedPSCellId is included in the SCGFailureInformation. If the SCG is an EUTRA SCG, the secondary cell group failure information transmitted by the terminal device to the network device is SCGFailureInformationEUTRA, that is, the information element failedPSCellId is included in the SCGFailureInformationEUTRA.

In summary, the secondary cell group failure information is transmitted to the network device in response to detecting that the specified event occurs in the secondary cell group. The secondary cell group failure information includes the identity of the primary secondary cell failing in addition. Thus, when a secondary cell group failure occurs, the information related to the conditional primary secondary cell (PSCell) addition or change can also be obtained by the network device, information related to the secondary cell group failure can be more comprehensively obtained by the network device, a reason for the secondary cell group failure can be more accurately analyzed, and communication efficiency of a system can be effectively improved.

With reference to FIG. 7, FIG. 7 is a flowchart of a method for reporting information according to an example of the disclosure. It should be noted that the method for reporting information in the example of the disclosure is performed by a network device. The method may be performed independently or in conjunction with any one of other examples of the disclosure. As shown in FIG. 7, the method may include step 701.

In step 701, secondary cell group failure information transmitted by a terminal device is received, where the secondary cell group failure information includes information related to a conditional primary secondary cell (PSCell) addition or change.

In the example of the disclosure, the terminal device triggers reporting of the secondary cell group failure information in response to detecting that the specified event occurs in the secondary cell group (SCG), the network device receives the secondary cell group failure information transmitted by the terminal device. The secondary cell group failure information includes the information related to the conditional PSCell addition or change.

In the example of the disclosure, the information related to the conditional PSCell addition or change includes at least one of the following:
candidate cell list information for the conditional PSCell addition or change;
a time interval from receiving conditional configuration information for the conditional PSCell addition or change to performing the conditional PSCell addition or change;
a time interval from receiving the conditional configuration information for the conditional PSCell addition or change to occurring a radio link failure;
a time interval from receiving the conditional configuration information for the conditional PSCell addition or change to occurring a beam failure;
a type of the PSCell addition or change last performed before detecting that a specified event occurs in a secondary cell group; or
the identity of a primary secondary cell failing in addition.

The conditional configuration information for the conditional PSCell addition or change refers to a conditional triggered event configured by the network device to the terminal device to trigger the PSCell addition or change.

Types of the PSCell addition or change include a conditional PSCell addition, a conditional PSCell change, a PSCell addition, and a PSCell change.

In some embodiments, the candidate cell list information for the conditional PSCell addition or change includes a global cell identity and a tracking area code of each candidate cell.

In some embodiments, the candidate cell list information for the conditional PSCell addition or change includes a physical cell identity and a carrier frequency of each candidate cell.

In some embodiments, the identity of the primary secondary cell failing in addition includes a physical cell identity and a carrier frequency of a PSCell failing in addition.

It should be noted that in the example of the disclosure, the information related to the conditional PSCell addition or change may be indicated by indication information in the secondary cell group failure information. For example, as an instance, the information related to the conditional PSCell addition or change may be indicated by an information element (IE) in the secondary cell group failure information. The IE may be newly defined. In some embodiments, an existing IE may also be reused to indicate the information related to the conditional PSCell addition or change.

In some embodiments, in response to determining that a reason for a secondary cell group failure is a PSCell addition or change failure, the information related to the conditional PSCell addition or change includes the time interval from receiving the conditional configuration information for the conditional PSCell addition or change from the terminal device to performing the conditional PSCell addition or change.

In some embodiments, in response to determining that a reason for a secondary cell group failure is a radio link failure, the information related to the conditional PSCell addition or change includes the time interval from receiving the conditional configuration information for the conditional PSCell addition or change from the terminal device to occurring the radio link failure.

In some embodiments, in response to determining that a reason for a secondary cell group failure is a beam failure, the information related to the conditional PSCell addition or change includes the time interval from receiving the conditional configuration information for the conditional PSCell addition or change from the terminal device to occurring the beam failure.

In some embodiments, in response to determining that a reason for a secondary cell group failure is a PSCell addition failure, the information related to the conditional PSCell addition or change includes the identity of the primary secondary cell failing in addition; and the primary secondary cell identity includes a physical cell identity and a carrier frequency of the primary secondary cell.

Alternatively, in some embodiments, the specified event includes at least one of the following, that is, the method provided in the example of the disclosure is applicable to at least one of the following situations of triggering reporting of the secondary cell group failure information:
a radio link failure for the secondary cell group;
reconfiguration with a synchronization failure of the secondary cell group; or
detecting a beam failure of the primary secondary cell (PSCell) of the secondary cell group while the secondary cell group is deactivated.

Alternatively, in some embodiments, the specified event may further include at least one of the following, that is, the method provided in the example of the disclosure is further applicable to at least one of the following situations of triggering reporting the secondary cell group failure information:
an integrity check failure from secondary cell group lower layers concerning signaling radio bearer type 3 (SRB3); or
a secondary cell group configuration failure.

Alternatively, in some embodiments, the method provided in the example of the disclosure is inapplicable to a situation of detecting that at least one of the following events occurs in the secondary cell group, that is, the method is inapplicable to at least one of the following situations of triggering reporting of the secondary cell group failure information:
an integrity check failure from secondary cell group lower layers concerning signaling radio bearer type 3 (SRB3);
a secondary cell group configuration failure; or
detecting a beam failure of a primary secondary cell (PSCell) of the secondary cell group while the secondary cell group is deactivated.

It can be understood that in the example of the disclosure, the situation of triggering reporting of the secondary cell group failure information to which the method is applicable or inapplicable may be specified by a protocol or determined by an indication of the network device.

Moreover, it should be noted that the secondary cell group (SCG) in the example of the disclosure may be an NR SCG or an EUTRA SCG. If the SCG is an NR SCG, the secondary cell group failure information transmitted by the terminal device to the network device is SCGFailureInformation, that is, the information related to the conditional PSCell addition or change is included in the SCGFailureInformation. If the SCG is an EUTRA SCG, the secondary cell group failure information transmitted by the terminal device to the network device is SCGFailureInformationEUTRA, that is, the information related to the conditional PSCell addition or change is included in the SCGFailureInformationEUTRA.

In summary, the secondary cell group failure information transmitted by the terminal device may be received. The secondary cell group failure information includes the information related to the conditional primary secondary cell (PSCell) addition or change. Thus, when a secondary cell group failure occurs, the information related to the conditional primary secondary cell (PSCell) addition or change can also be obtained by the network device, information related to the secondary cell group failure can be more comprehensively obtained by the network device, a reason for the secondary cell group failure can be more accurately analyzed, and communication efficiency of a system can be effectively improved.

Corresponding to the method for reporting information provided in the above examples, the disclosure further provides an apparatus for reporting information. Since the apparatus for reporting information provided in the examples of the disclosure corresponds to the method provided in the above examples, an embodiment of the method for reporting information is also applicable to the apparatus for reporting information provided in the following examples, which will not be described in detail in the following examples.

With reference to FIG. 8, FIG. 8 is a schematic structural diagram of an apparatus for reporting information according to an example of the disclosure.

As shown in FIG. 8, the apparatus 800 for reporting information includes a transceiving unit 810.

The transceiving unit 810 is configured to transmit secondary cell group failure information to a network device in response to detecting that a specified event occurs in a secondary cell group.

The secondary cell group failure information includes information related to a conditional primary secondary cell (PSCell) addition or change.

Alternatively, the information related to the conditional primary secondary cell (PSCell) addition or change includes at least one of the following:
candidate cell list information for the conditional primary secondary cell (PSCell) addition or change;
a time interval from receiving conditional configuration information for the conditional primary secondary cell (PSCell) addition or change to performing the conditional primary secondary cell (PSCell) addition or change;
a time interval from receiving the conditional configuration information for the conditional primary secondary cell (PSCell) addition or change to occurring a radio link failure;
a time interval from receiving the conditional configuration information for the conditional primary secondary cell (PSCell) addition or change to occurring a beam failure;
a type of the primary secondary cell (PSCell) addition or change last performed before detecting that the specified event occurs in the secondary cell group; or
the identity of a primary secondary cell failing in addition.

Alternatively, the specified event includes at least one of the following:
a radio link failure for the secondary cell group;
reconfiguration with a synchronization failure of the secondary cell group; or
detecting a beam failure of a primary secondary cell (PSCell) of the secondary cell group while the secondary cell group is deactivated.

Alternatively, the apparatus is inapplicable to a situation of detecting that at least one of the following events occurs in the secondary cell group:
an integrity check failure from secondary cell group lower layers concerning signaling radio bearer type 3 (SRB3);
a secondary cell group configuration failure; or
detecting a beam failure of a primary secondary cell (PSCell) of the secondary cell group while the secondary cell group is deactivated.

Alternatively, in response to determining that a reason for a secondary cell group failure is a primary secondary cell (PSCell) addition or change failure and that available conditional configuration information for the conditional primary secondary cell (PSCell) addition or change exists, the candidate cell list information for the conditional primary secondary cell (PSCell) addition or change includes a global cell identity and a tracking area code of each candidate cell.

Alternatively, in response to determining that a reason for a secondary cell group failure is a primary secondary cell (PSCell) addition or change failure and that available conditional configuration information for the conditional primary secondary cell (PSCell) addition or change exists, the candidate cell list information for the conditional primary secondary cell (PSCell) addition or change includes a physical cell identity and a carrier frequency of each candidate cell.

Alternatively, the candidate cell list information for the conditional primary secondary cell (PSCell) addition or change does not include a serving cell and a neighboring cell in the secondary cell group failure information.

Alternatively, in response to determining that a reason for a secondary cell group failure is a primary secondary cell (PSCell) addition or change failure, the information related to the conditional primary secondary cell (PSCell) addition or change includes the time interval from receiving the conditional configuration information for the conditional primary secondary cell (PSCell) addition or change to performing the conditional primary secondary cell (PSCell) addition or change.

Alternatively, in response to determining that a reason for a secondary cell group failure is a radio link failure, the information related to the conditional primary secondary cell (PSCell) addition or change includes the time interval from receiving the conditional configuration information for the conditional primary secondary cell (PSCell) addition or change to occurring the radio link failure.

Alternatively, in response to determining that a reason for a secondary cell group failure is a beam failure, the information related to the conditional primary secondary cell (PSCell) addition or change includes the time interval from receiving the conditional configuration information for the conditional primary secondary cell (PSCell) addition or change to occurring the beam failure.

Alternatively, types of the primary secondary cell (PSCell) addition or change include a conditional primary secondary cell (PSCell) addition, a conditional primary secondary cell (PSCell) change, a primary secondary cell (PSCell) addition, and a primary secondary cell (PSCell) change.

Alternatively, in response to determining that a reason for a secondary cell group failure is a primary secondary cell (PSCell) addition failure, the information related to the conditional primary secondary cell (PSCell) addition or change includes the identity of the primary secondary cell failing in addition; and the identity of the primary secondary cell failing in addition includes a physical cell identity and a carrier frequency of the primary secondary cell.

According to the apparatus for reporting information in the example, the secondary cell group failure information may be transmitted to the network device in response to detecting that the specified event occurs in the secondary cell group. The secondary cell group failure information includes the information related to the conditional primary secondary cell (PSCell) addition or change. Thus, when a secondary cell group failure occurs, the information related to the conditional primary secondary cell (PSCell) addition or change can also be obtained by the network device, information related to the secondary cell group failure can be more comprehensively obtained by the network device, a reason for the secondary cell group failure can be more accurately analyzed, and communication efficiency of a system can be effectively improved.

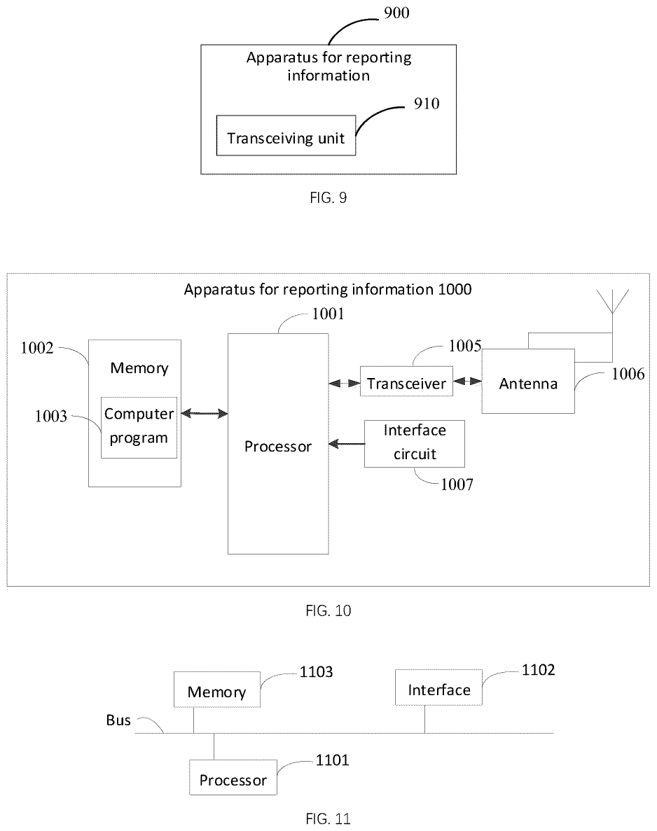

With reference to FIG. 9, FIG. 9 is a schematic structural diagram of an apparatus for reporting information according to an example of the disclosure.

As shown in FIG. 9, the apparatus 900 for reporting information includes a transceiving unit 910.

The transceiving unit 910 is configured to receive secondary cell group failure information transmitted by a terminal device.

The secondary cell group failure information includes information related to a conditional primary secondary cell (PSCell) addition or change.

Alternatively, the information related to the conditional primary secondary cell (PSCell) addition or change includes at least one of the following:
candidate cell list information for the conditional primary secondary cell (PSCell) addition or change;
a time interval from receiving conditional configuration information for the conditional primary secondary cell (PSCell) addition or change from the terminal device to performing the conditional primary secondary cell (PSCell) addition or change;
a time interval from receiving the conditional configuration information for the conditional primary secondary cell (PSCell) addition or change from the terminal device to occurring a radio link failure;
a time interval from receiving the conditional configuration information for the conditional primary secondary cell (PSCell) addition or change from the terminal device to occurring a beam failure;
a type of the primary secondary cell (PSCell) addition or change last performed before detecting that a specified event occurs in a secondary cell group; or
the identity of a primary secondary cell failing in addition.

Alternatively, the specified event includes at least one of the following:
a radio link failure for the secondary cell group;
reconfiguration with a synchronization failure of the secondary cell group; or
detecting a beam failure of a primary secondary cell (PSCell) of the secondary cell group while the secondary cell group is deactivated.

Alternatively, the apparatus is inapplicable to a situation of detecting that at least one of the following events occurs in the secondary cell group:
an integrity check failure from secondary cell group lower layers concerning signaling radio bearer type 3 (SRB3);
a secondary cell group configuration failure; or
detecting a beam failure of a primary secondary cell (PSCell) of the secondary cell group while the secondary cell group is deactivated.

Alternatively, in response to determining that a reason for a secondary cell group failure is a primary secondary cell (PSCell) addition or change failure and that available conditional configuration information for the conditional primary secondary cell (PSCell) addition or change exists, the candidate cell list information for the conditional primary secondary cell (PSCell) addition or change includes a global cell identity and a tracking area code of each candidate cell.

Alternatively, in response to determining that a reason for a secondary cell group failure is a primary secondary cell (PSCell) addition or change failure and that available conditional configuration information for the conditional primary secondary cell (PSCell) addition or change exists, the candidate cell list information for the conditional primary secondary cell (PSCell) addition or change includes a physical cell identity and a carrier frequency of each candidate cell.

Alternatively, the candidate cell list information for the conditional primary secondary cell (PSCell) addition or change does not include a serving cell and a neighboring cell in the secondary cell group failure information.

Alternatively, in response to determining that a reason for a secondary cell group failure is a primary secondary cell (PSCell) addition or change failure, the information related to the conditional primary secondary cell (PSCell) addition or change includes the time interval from receiving the conditional configuration information for the conditional primary secondary cell (PSCell) addition or change from the terminal device to performing the conditional primary secondary cell (PSCell) addition or change.

Alternatively, in response to determining that a reason for a secondary cell group failure is a radio link failure, the information related to the conditional primary secondary cell (PSCell) addition or change includes the time interval from receiving the conditional configuration information for the conditional primary secondary cell (PSCell) addition or change from the terminal device to occurring the radio link failure.

Alternatively, in response to determining that a reason for a secondary cell group failure is a beam failure, the information related to the conditional primary secondary cell (PSCell) addition or change includes the time interval from receiving the conditional configuration information for the conditional primary secondary cell (PSCell) addition or change from the terminal device to occurring the beam failure.

Alternatively, types of the primary secondary cell (PSCell) addition or change include a conditional primary secondary cell (PSCell) addition, a conditional primary secondary cell (PSCell) change, a primary secondary cell (PSCell) addition, and a primary secondary cell (PSCell) change.

Alternatively, in response to determining that a reason for a secondary cell group failure is a primary secondary cell (PSCell) addition failure, the information related to the conditional primary secondary cell (PSCell) addition or change includes the identity of the primary secondary cell failing in addition; and the identity of the primary secondary cell failing in addition includes a physical cell identity and a carrier frequency of the primary secondary cell.

According to the apparatus for reporting information in the example, the secondary cell group failure information transmitted by the terminal device may be received. The secondary cell group failure information includes the information related to the conditional primary secondary cell (PSCell) addition or change. Thus, when a secondary cell group failure occurs, the information related to the conditional primary secondary cell (PSCell) addition or change can also be obtained by the network device, information related to the secondary cell group failure can be more comprehensively obtained by the network device, a reason for the secondary cell group failure can be more accurately analyzed, and communication efficiency of a system can be effectively improved.

In order to implement the above example, the examples of the disclosure further provide a communication apparatus. The communication apparatus includes a processor and a memory. The memory stores a computer program. The processor executes the computer program stored in the memory to cause the apparatus to perform the method shown in the examples of FIGS. 2-6.

In order to implement the above example, the examples of the disclosure further provide a communication apparatus. The communication apparatus includes a processor and a memory. The memory stores a computer program. The processor executes the computer program stored in the memory to cause the apparatus to perform the method shown in the examples of FIG. 7.

In order to implement the above example, the examples of the disclosure further provide a communication apparatus. The communication apparatus includes a processor and an interface circuit. The interface circuit is configured to receive a code instruction and transmit the code instruction to the processor. The processor is configured to run the code instruction to perform the method shown in the examples of FIGS. 2-6.

In order to implement the above example, the examples of the disclosure further provide a communication apparatus. The communication apparatus includes a processor and an interface circuit. The interface circuit is configured to receive a code instruction and transmit the code instruction to the processor. The processor is configured to run the code instruction to perform the method shown in the examples of FIG. 7.

With reference to FIG. 10, FIG. 10 is a schematic structural diagram of another apparatus for reporting information according to an example of the disclosure. The apparatus 1000 for reporting information may be a network device, may be a terminal device, may be a chip, a chip system, or a processor that supports a network device to implement the above method, and may also be a chip, a chip system, or a processor that supports a terminal device to implement the above method. The apparatus may be configured to implement the methods described in the above method examples, and reference may be made to description in the above method examples for details.

The apparatus 1000 for reporting information may include one or more processors 1001. The processor 1001 may be a general purpose processor or a special purpose processor, etc., such as a baseband processor or a central processor. The baseband processor may be configured to process a communication protocol and communication data. The central processor may be configured to control an apparatus for reporting information (for example, a base station, a baseband chip, a terminal device, a terminal device chip, a DU or a CU), execute a computer program, and process data of the computer program.

Alternatively, the apparatus 1000 for reporting information may further include one or more memories 1002 that may store a computer program 1003. The processor 1001 executes the computer program 1003 to cause the apparatus 1000 for reporting information to perform the method described in the above method examples. The computer program 1003 may be embedded in the processor 1001. In this case, the processor 1001 may be implemented by hardware.

Alternatively, the memory 1002 may also store data. The apparatus 1000 for reporting information and the memory 1002 may be set separately or may be integrated together.

Alternatively, the apparatus 1000 for reporting information may further include a transceiver 1005 and an antenna 1006. The transceiver 1005 may be referred to as a transceiving unit, a transceiving machine, or a transceiving circuit, etc., and is configured to implement a transceiving function. The transceiver 1005 may include a receiver and a transmitter. The receiver may be referred to as a receiving machine or a receiving circuit, etc., for implementing a reception function. The transmitter may be referred to as a transmitting machine or a transmitting circuit, etc., for implementing a transmission function.

Alternatively, the apparatus 1000 for reporting information may further include one or more interface circuits 1007. The interface circuit 1007 is configured to receive a code instruction and transmit the code instruction to the processor 1001. The processor 1001 carry out the code instruction to cause the apparatus 1000 for reporting information to perform the method described in the above method examples.

When the apparatus 1000 for reporting information is a terminal device, the transceiver 1005 is configured to perform step 201 in FIG. 2, step 301 in FIG. 3, step 401 in FIG. 4, step 501 in FIG. 5, and step 601 in FIG. 6.

When the apparatus 1000 for reporting information is a network device, the transceiver 1005 is configured to perform steps 701 in FIG. 7.

In an implementation, the processor 1001 may include a transceiver for implementing a reception function and a transmission function. For example, the transceiver may be a transceiving circuit, or an interface, or an interface circuit. The transceiving circuit, interface, or interface circuit for implementing the reception function and the transmission function may be separated or integrated. The transceiving circuit, interface or interface circuit may be configured to read and write a code/data, and alternatively, the transceiving circuit, interface or interface circuit may be configured to transmit or transfer a signal.

In an implementation, the apparatus 1000 for reporting information may include a circuit that may implement the functions of transmission, reception or communication in the foregoing method examples. The processor and transceiver described in the disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver may also be fabricated by using various IC process technologies, such as a complementary metal oxide semiconductor (CMOS), an n-metal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The apparatus for reporting information described in the above examples may be a network device or a terminal device. The scope of the apparatus for reporting information described in the disclosure is not limited to this, and a structure of the apparatus for reporting information may not be limited by FIGS. 8-9. The apparatus for reporting information may be a stand-alone device or may be part of a larger device. For example the apparatus for reporting information may be:
(1) an independent integrated circuit (IC), a chip, a chip system or a subsystem;
(2) a set of one or more ICs, alternatively including a memory component for storing data and a computer program;
(3) an ASIC, such as a modem;
(4) a module that can be embedded in other devices;
(5) a receiver machine, a terminal device, an intelligent terminal device, a cellular phone, a radio device, a handset, a mobile unit, a vehicle-mounted device, a network device, a cloud device, an artificial intelligence device, etc.; and
(6) a different apparatus, etc.

Reference may be made to a schematic structural diagram of a chip shown in FIG. 11 for the case that the apparatus for reporting information may be a chip or a chip system. The chip shown in FIG. 11 includes a processor 1101 and an interface 1102. One or more processors 1101 may be provided. A plurality of interfaces 1102 may be provided.

For a case that the chip is configured to implement the function of the network device in the example of the disclosure:
the interface 1102 is configured to receive a code instruction and transmit the code instruction to the processor; and
the processor 1101 is configured to run the code instruction to perform the method as shown in FIGS. 2-6.

For a case that the chip is configured to implement the function of the terminal device in the example of the disclosure:
the interface 1102 is configured to receive a code instruction and transmit the code instruction to the processor; and
the processor 1101 is configured to run the code instruction to perform the method as shown in FIG. 7.

Alternatively, the chip further includes a memory 1103. The memory 1103 is configured to store a necessary computer program and data.

Those skilled in the art will further appreciate that the various illustrative logical blocks and steps set forth in the examples of the disclosure may be implemented by electronic hardware, computer software, or combinations of both. Whether such functions are implemented by hardware or software depends on a particular application and overall system design requirements. Those skilled in the art may use various methods to implement the functions for each particular application, but such implementation should not be understood as beyond the scope of protection of the examples of the disclosure.

The examples of the disclosure further provide a communication system. The system includes the apparatus for reporting information serving as a terminal device and the apparatus for reporting information serving as a network device in the examples of FIGS. 8-9. Alternatively, the system includes the apparatus for reporting information serving as a terminal device and the apparatus for reporting information serving as a network device in the example of FIG. 10.

The disclosure further provides a non-transitory readable storage medium. The readable storage medium stores an instruction. The instruction implements the functions of any one of the method examples when executed by a computer.

The disclosure further provides a computer program product. The computer program product implements the functions of the method examples when executed by a computer.

The examples described above can be implemented in whole or in part by software, hardware, firmware, or their any combinations. When implemented through the software, all or some of the modules may be implemented in the form of computer program products. The computer program product includes one or more computer programs. When loaded and executed on a computer, the computer program generates in whole or in part the flows or functions described in accordance with the examples of the disclosure. The computer may be a general purpose computer, a special purpose computer, a computer network, or other programmable apparatuses. The computer program may be stored in a non-transitory computer-readable storage medium or transmitted by one non-transitory computer-readable storage medium to another non-transitory computer-readable storage medium. For example, the computer program can be transmitted by one website, computer, server, or data center to another website, computer, server, or data center through a wired means (for example, a coaxial cable, an optical fiber, and a digital subscriber line (DSL)) or a wireless means (for example, infrared, radio waves, and microwaves). The non-transitory computer-readable storage medium may be any available medium that can be accessed by a computer or a data storage device including one or more available media integrated as a server, data center, etc. The available medium may be a magnetic medium (for example, floppy disk, hard disk, magnetic tape), an optical medium (for example, digital video disk (DVD)), or a semiconductor medium (for example, solid state disk (SSD)), etc.

Those skilled in the art may understand that the first, second and other numerical numbers referred to in the disclosure are merely for distinction for convenience of description, instead of limiting the scope of the examples of the disclosure, and represent the order of sequence.

At least one in the disclosure may also be described as one or more, and the plurality may be two, three, four, or more, which are not limited in the disclosure. In the examples of the disclosure, for a type of technical features, technical features in this type of the technical features are distinguished by “first”, “second”, “third”, “A”, “B”, “C” and “D”, and the technical features described by the “first”, “second”, “third”, “A”, “B”, “C” and “D” are not in order of sequence or order of magnitude.

Corresponding relations shown in tables of the disclosure may be configured or predefined. Values of information in each table are only instances, and may be configured differently, which is not limited in the disclosure. When a corresponding relation between the information and each parameter is configured, it is not necessarily required to configure all the corresponding relations indicated in each table. For example, in the tables of the disclosure, the corresponding relations shown in some rows may not be configured. For another example, appropriate deformation adjustments, such as splitting, merging, etc., can be made based on the above table. Names of the parameters shown in the titles of the above tables may also be other names that can be understood by the communication apparatus, and values or expression modes of the parameters may also be other values or expression modes that can be understood by the communication apparatus. When the tables are implemented, other data structures may also be used, such as an array, a queue, a container, a stack, a linear table, a pointer, a linked list, a tree, a graph, a structure, a class, a heap, and a hash table.

Predefinition in the disclosure may be understood as definition, predefinition, storage, pre-storage, pre-negotiation, pre-configuration, curing, or pre-firing.

Those of ordinary skill in the art may appreciate that the units and algorithm steps of the instances described in conjunction with the examples disclosed here may be implemented in electronic hardware, or a combination of computer software and electronic hardware. Whether these functions are performed with hardware or software depends on the specific application and design constraints of the technical solution. Those skilled in the art can use different methods to implement the described functions for each particular application, but such implementation should not be deemed as falling beyond the scope of the disclosure.

Those skilled in the art will clearly appreciate that, for convenience and conciseness of description, reference can be made to corresponding processes in the foregoing method examples for specific working processes of the above systems, devices and units, which are not repeated here.

It should be understood that the various forms of the flows shown above may be used, with steps being reordered, added, or deleted. For instance, steps described in the examples of the disclosure may be performed in parallel, performed sequentially, or performed in a different order, as long as desired results of the technical solutions disclosed in the disclosure can be achieved, which is not limited here.

The above specific embodiments do not limit the scope of protection of the disclosure. Those skilled in the art will appreciate that various modifications, combinations, subcombinations, and substitutions may be made according to design requirements and other factors. Any modifications, equivalent substitutions, improvements, etc. made within the spirit and principle of the disclosure should be included within the scope of protection of the disclosure.

1. A method for reporting information, performed by a terminal device, comprising:
transmitting secondary cell group failure information to a network device in response to detecting that a specified event occurs in a secondary cell group, wherein the secondary cell group failure information comprises information related to a conditional primary secondary cell (PSCell) addition or change.

2. The method according to claim 1, wherein the information related to the conditional primary secondary cell (PSCell) addition or change comprises at least one of:
candidate cell list information for the conditional primary secondary cell (PSCell) addition or change;
a time interval from receiving conditional configuration information for the conditional primary secondary cell (PSCell) addition or change to performing the conditional primary secondary cell (PSCell) addition or change;
a time interval from receiving the conditional configuration information for the conditional primary secondary cell (PSCell) addition or change to occurring a radio link failure;
a time interval from receiving the conditional configuration information for the conditional primary secondary cell (PSCell) addition or change to occurring a beam failure;
a type of the primary secondary cell (PSCell) addition or change last performed before detecting that the specified event occurs in the secondary cell group; or
the identity of a primary secondary cell failing in addition.

3. The method according to claim 1, wherein the specified event comprises at least one of:
a radio link failure for the secondary cell group;
reconfiguration with a synchronization failure of the secondary cell group; or
detecting a beam failure of a primary secondary cell (PSCell) of the secondary cell group while the secondary cell group is deactivated.

4. The method according to claim 2, wherein in response to determining that a reason for a secondary cell group failure is a primary secondary cell (PSCell) addition or change failure and that available conditional configuration information for the conditional primary secondary cell (PSCell) addition or change exists, the candidate cell list information for the conditional primary secondary cell (PSCell) addition or change comprises a global cell identity and a tracking area code of each candidate cell.

5. The method according to claim 2, wherein in response to determining that a reason for a secondary cell group failure is a primary secondary cell (PSCell) addition or change failure and that available conditional configuration information for the conditional primary secondary cell (PSCell) addition or change exists, the candidate cell list information for the conditional primary secondary cell (PSCell) addition or change comprises a physical cell identity and a carrier frequency of each candidate cell.

6. The method according to claim 4, wherein the candidate cell list information for the conditional primary secondary cell (PSCell) addition or change does not comprise a serving cell and a neighboring cell in the secondary cell group failure information.

7. The method according to claim 2, wherein in response to determining that a reason for a secondary cell group failure is a primary secondary cell (PSCell) addition or change failure, the information related to the conditional primary secondary cell (PSCell) addition or change comprises the time interval from receiving the conditional configuration information for the conditional primary secondary cell (PSCell) addition or change to performing the conditional primary secondary cell (PSCell) addition or change.

8. The method according to claim 2, wherein in response to determining that a reason for a secondary cell group failure is a radio link failure, the information related to the conditional primary secondary cell (PSCell) addition or change comprises the time interval from receiving the conditional configuration information for the conditional primary secondary cell (PSCell) addition or change to occurring the radio link failure.

9. The method according to claim 2, wherein in response to determining that a reason for a secondary cell group failure is a beam failure, the information related to the conditional primary secondary cell (PSCell) addition or change comprises the time interval from receiving the conditional configuration information for the conditional primary secondary cell (PSCell) addition or change to occurring the beam failure.

10. The method according to claim 2, wherein types of the primary secondary cell (PSCell) addition or change comprise at least one of: a conditional primary secondary cell (PSCell) addition, a conditional primary secondary cell (PSCell) change, a primary secondary cell (PSCell) addition, or a primary secondary cell (PSCell) change.

11. The method according to claim 2, wherein in response to determining that a reason for a secondary cell group failure is a primary secondary cell (PSCell) addition failure, the information related to the conditional primary secondary cell (PSCell) addition or change comprises the identity of the primary secondary cell failing in addition; and the identity of the primary secondary cell failing in addition comprises a physical cell identity and a carrier frequency of the primary secondary cell.

12. A method for reporting information, performed by a network device, comprising:
receiving secondary cell group failure information transmitted by a terminal device, wherein
the secondary cell group failure information comprises information related to a conditional primary secondary cell (PSCell) addition or change.

13. The method according to claim 12, wherein the information related to the conditional primary secondary cell (PSCell) addition or change comprises at least one of:
candidate cell list information for the conditional primary secondary cell (PSCell) addition or change;
a time interval from receiving conditional configuration information for the conditional primary secondary cell (PSCell) addition or change from the terminal device to performing the conditional primary secondary cell (PSCell) addition or change;
a time interval from receiving the conditional configuration information for the conditional primary secondary cell (PSCell) addition or change from the terminal device to occurring a radio link failure;
a time interval from receiving the conditional configuration information for the conditional primary secondary cell (PSCell) addition or change from the terminal device to occurring a beam failure;
a type of the primary secondary cell (PSCell) addition or change last performed before detecting that a specified event occurs in a secondary cell group; or
the identity of a primary secondary cell failing in addition.

14. The method according to claim 13, wherein the specified event comprises at least one of:
a radio link failure for the secondary cell group;
reconfiguration with a synchronization failure of the secondary cell group; or
detecting a beam failure of a primary secondary cell (PSCell) of the secondary cell group while the secondary cell group is deactivated.

15. The method according to claim 13, wherein in response to determining that a reason for a secondary cell group failure is a primary secondary cell (PSCell) addition or change failure and that available conditional configuration information for the conditional primary secondary cell (PSCell) addition or change exists, the candidate cell list information for the conditional primary secondary cell (PSCell) addition or change comprises a global cell identity and a tracking area code of each candidate cell.

16. The method according to claim 13, wherein in response to determining that a reason for a secondary cell group failure is a primary secondary cell (PSCell) addition or change failure and that available conditional configuration information for the conditional primary secondary cell (PSCell) addition or change exists, the candidate cell list information for the conditional primary secondary cell (PSCell) addition or change comprises a physical cell identity and a carrier frequency of each candidate cell.

17. (canceled)

18. The method according to claim 13, wherein in response to determining that a reason for a secondary cell group failure is a primary secondary cell (PSCell) addition or change failure, the information related to the conditional primary secondary cell (PSCell) addition or change comprises the time interval from receiving the conditional configuration information for the conditional primary secondary cell (PSCell) addition or change from the terminal device to performing the conditional primary secondary cell (PSCell) addition or change.

19-24. (canceled)

25. A communication apparatus, comprising a processor and a memory, wherein the memory stores a computer program, and the processor executes the computer program stored in the memory to cause the apparatus to perform:
transmitting secondary cell group failure information to a network device in response to detecting that a specified event occurs in a secondary cell group, wherein
the secondary cell group failure information comprises information related to a conditional primary secondary cell (PSCell) addition or change.

26. (canceled)

27. A communication apparatus, comprising a processor and an interface circuit, wherein
the interface circuit is configured to receive a code instruction and transmit the code instruction to the processor; and
the processor is configured to run the code instruction to perform the method according to claim 1.

28. (canceled)

29. A non-transitory computer-readable storage medium,
configured to store an instruction, wherein the instruction causes the method according to claim 1 to be implemented when executed.

30. (canceled)
